(19) United States
(12) Patent Application Publication
(10) Pub. No.: US 2009/0129909 A1
(43) Pub. Date: May 21, 2009

(54) FOOTWEAR-MOVING DEVICE MOVABLE ALONG WITH A DOOR PANEL

(76) Inventor: Shui-Ming TSAI, Chiayi City (TW)

Correspondence Address: LADAS & PARRY LLP, 224 SOUTH MICHIGAN AVENUE, SUITE 1600, CHICAGO, IL, 60604, US

(21) Appl. No.: 12/271,970

(22) Filed: Nov. 17, 2008

(30) Foreign Application Priority Data
Nov. 21, 2007 (TW) 096144079

(51) Int. Cl. B65G 1/133

(52) U.S. Cl. 414/749.1; 414/749.6; 414/800

(57) ABSTRACT

A device is operable by a door panel for moving a footwear article between a use position that is near a door opening and a store position that is away from the door opening. The device includes a carrier having a footwear support, and a link member connecting the carrier to the door panel so that the carrier moves along with closing and opening movements of the door panel. A method for moving the footwear article is also disclosed.

### CROSS-REFERENCE TO RELATED APPLICATION

This application claims priority of Taiwanese Application No. 096144079, filed on Nov. 21, 2007.

### BACKGROUND OF THE INVENTION

1. Field of the Invention

This invention relates to a footwear-moving device, more particularly to a footwear-moving device having a carrier connected movably to a door panel.

2. Description of the Related Art

Generally, to maintain cleanliness in the house or in the bathroom, changing of footwear, such as shoes or slippers, is necessary when entering or exiting the house or the bathroom. However, the footwear used for such purposes is often caught between a gap between a bottom end of the door panel and the floor, thereby adversely affecting opening or closing movement of the door panel. To resolve this problem, the user usually places the footwear outside the range of a pivoting movement of the door panel, for example, beside the door panel. However, to wear or remove the footwear, the user must rotate each foot after stepping into or to step out of the room or house. This may cause the user to lose his/her balance and must therefore hold onto the door panel or a side frame of the door. Hence, wearing or removal of the footwear is inconvenient when entering or exiting the house or the bathroom.

### SUMMARY OF THE INVENTION

Therefore, the object of the present invention is to provide a device for moving a footwear article between a use position and a store position and that has a carrier movable along with closing and opening movements of a door panel.

According to one aspect of this invention, a device is operable by a door panel for moving a footwear article between a use position that is near a door opening and a store position that is away from the door opening. The device comprises a carrier having a footwear support, and a link member connecting the carrier to the door panel so that the carrier moves along with closing and opening movements of the door panel.

According to another aspect of this invention, a method for moving a footwear article between a use position that is near a door opening and a store position that is away from the door opening comprises the steps of: placing a footwear article on a carrier; moving a door panel to a close or open position; and transferring the movement of the door panel to the carrier so that the carrier is moved away from or toward the door opening.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a sectional top view of a device for moving a footwear article according to the preferred embodiment of the present invention;

FIG. 2 is a view similar to FIG. 1, but illustrating a door panel in an open position;

FIG. 3 is a fragmentary perspective view of a carrier and a guide rail of the preferred embodiment;

FIG. 4 is a sectional side view of the preferred embodiment;

FIG. 5 is a view similar to FIG. 1, but illustrating the door panel in a partially open position;

FIG. 6 is a fragmentary sectional side view of the preferred embodiment, illustrating an outer periphery of a slide roller in contact with an inner wall face of a sidewall of the guide rail;

FIG. 7 is a view similar to FIG. 6, but illustrating the outer periphery of the slide roller in contact with an inner wall face of another sidewall of the guide rail; and

FIG. 8 is an enlarged fragmentary sectional top view of the preferred embodiment.

### DETAILED DESCRIPTION OF THE PREFERRED EMBODIMENT

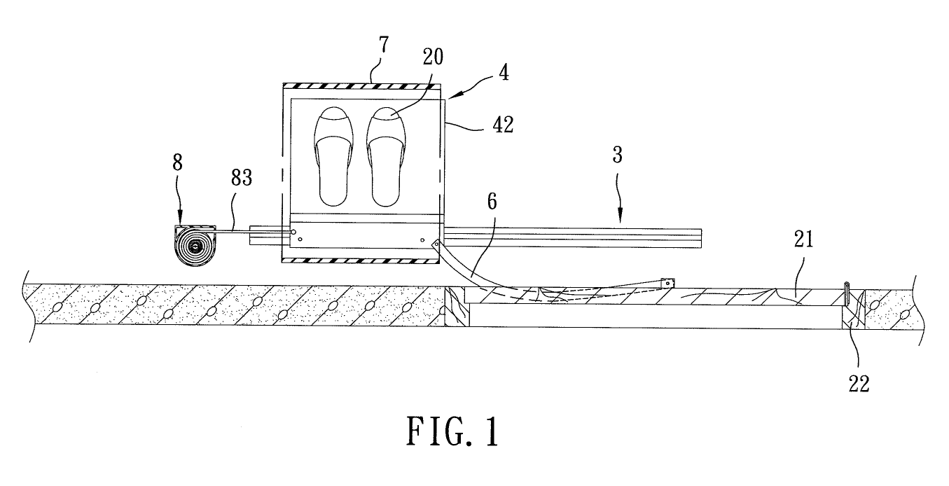

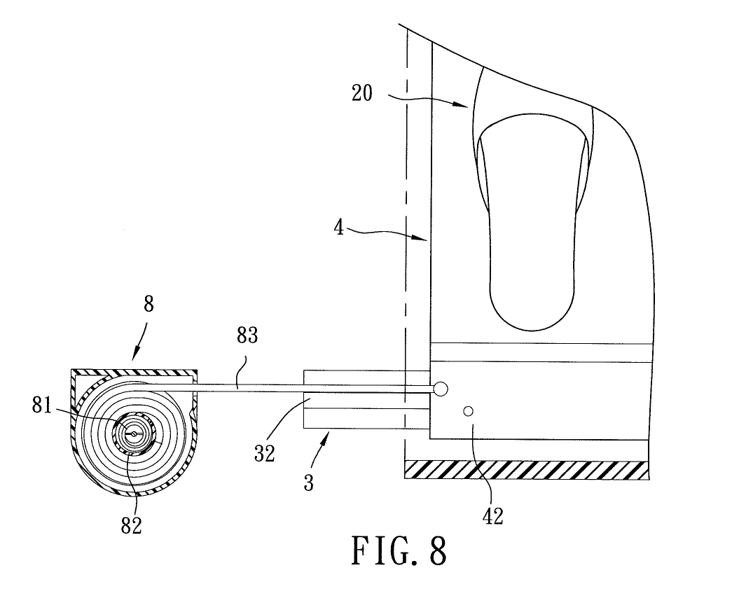

Referring to FIGS. 1 to 8, a device for moving a footwear article 20 according to the preferred embodiment of the present invention is shown to comprise a guide rail 3, a carrier 4, a link member 6, and a returning unit 8.

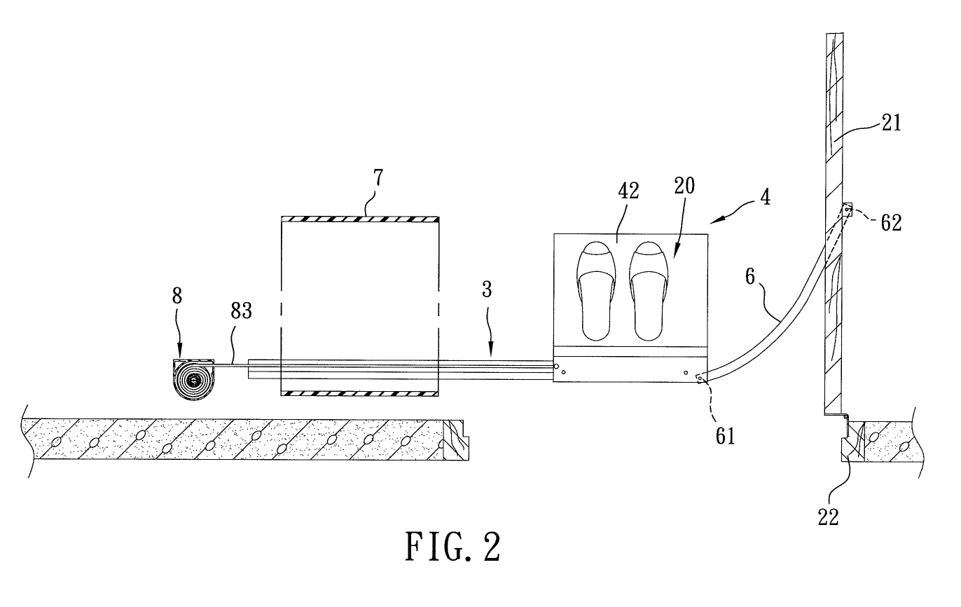

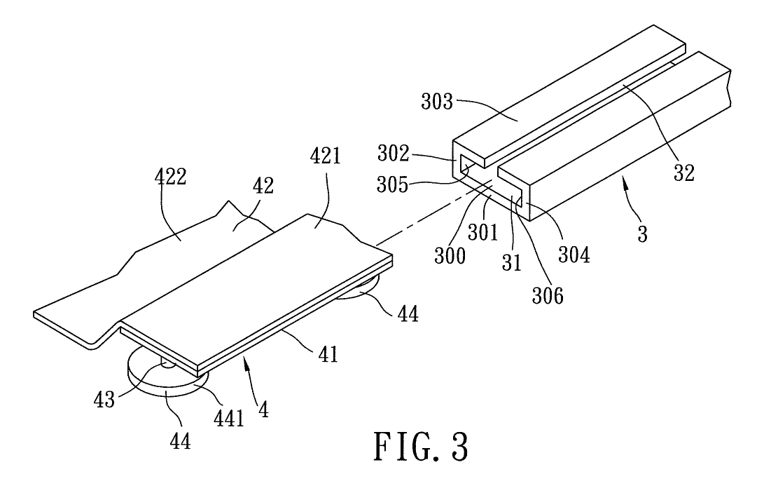

The guide rail 3 is adapted to be fixed on a floor in proximity to a door opening. The door opening has a door panel 21 with a right edge hinged to a door frame 22, so that the door panel 21 can move between a close position, as shown in FIG. 1, and an open position, as shown in FIG. 2. The guide rail 3 is located at a rear side of the door panel 21, and is parallel to the door panel 21 when the latter is moved to a close position. As shown in FIG. 3, the guide rail 3 defines a slide channel 300 having intercommunicating lower and upper slide sections 31, 32, and has a longitudinal bottom wall 301, a longitudinal top wall 303, and two opposite longitudinal sidewalls 302, 304 interconnecting the top and bottom walls 303, 301. The lower slide section 31 is defined between the top and bottom walls 303, 301 and between the sidewalls 302, 304. The top wall 303 is split to form the upper slide section 32. The upper slide section 32 is narrower than the lower slide section 31. Each sidewall 302, 304 has an inner wall face 305, 306.

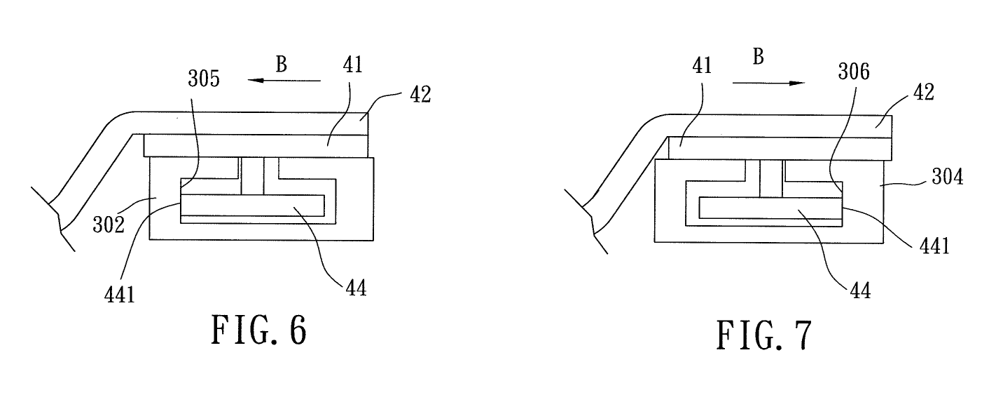

The carrier 4 is slidable on the guide rail 3 between a use position, as shown in FIG. 2, and a store position, as shown in FIG. 1. The carrier 4, as shown in FIG. 3, has a slide plate 41 slidable on top of the guide rail 3, two spaced-apart roller shafts 43 extending downwardly from a bottom face of the slide plate 41 and sliding within the upper slide section 32, two slide rollers 44 journalled respectively to bottom ends of the roller shafts 43 and sliding within the lower slide section 31, and a footwear support 42. In this embodiment, the footwear support 42 is a flexible sheet, and is attached to and extends transversely away from the slide plate 41. The footwear support 42 has a front portion 421 fixed to a top face of the slide plate 41, and a rear portion 422 adapted to support the footwear article 20, such as slippers. Preferably, outer peripheries 441 of the slide rollers 44 are only in contact with the inner wall face 305 of the sidewall 302, as shown in FIG. 6, or the inner wall face 306 of the sidewall 304, as shown in FIG. 7.

Since each slide roller 44 has a diameter larger than a width of the upper slide section 32, each slide roller 44 is limited to slide within the lower slide section 31. The link member 6, in this embodiment, is an elongated bar having one end 61 connected pivotally to the footwear support 42 and another end 62 adapted to be connected pivotally to a rear bottom end of the door panel 21.

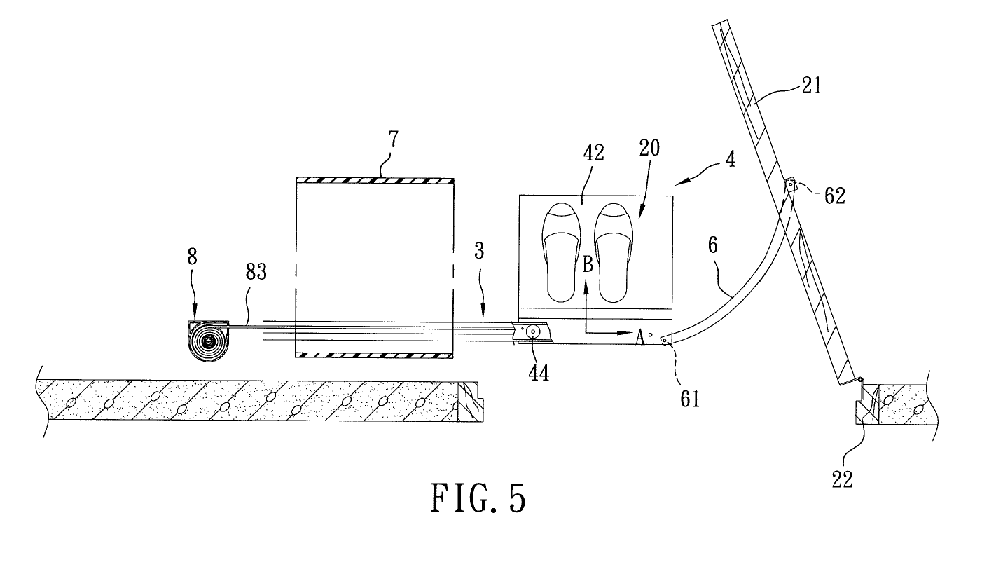

When the door panel 21 is pivoted from the close position, as shown in FIG. 1, to the open position, as shown in FIG. 2, the carrier 4 moves along with closing and opening movements of the door panel 21, and moves from the store position to the use position through the link member 6. With reference to FIG. 5, during movement of the door panel 21 from the open position to the close position or vice versa, the slide plate 41 (see FIG. 3) is pulled or pushed by the link member 6. As the pulling or pushing force of the slide plate 41 is inclined with respect to the guide rail 3, the slide plate 41 can move transversely of the guide rail 3 (by a slight amount) due to a force component (B) of the pulling or pushing force while moving along the guide rail 3 due to a force component (A). Referring to FIG. 6, when the slide plate 41 is moved transversely to one side, the outer periphery 441 of the slide roller 44 is in contact with the inner wall face 305 of the sidewall 302. Since an area of contact between the slide rollers 44 and the inner wall face 305 is small, friction between the same can be minimized. Referring to FIG. 7, when the slide plate 41 is moved to another side, the outer periphery 441 of the slide roller 44 is in contact with the inner wall face 306 of the sidewall 304.

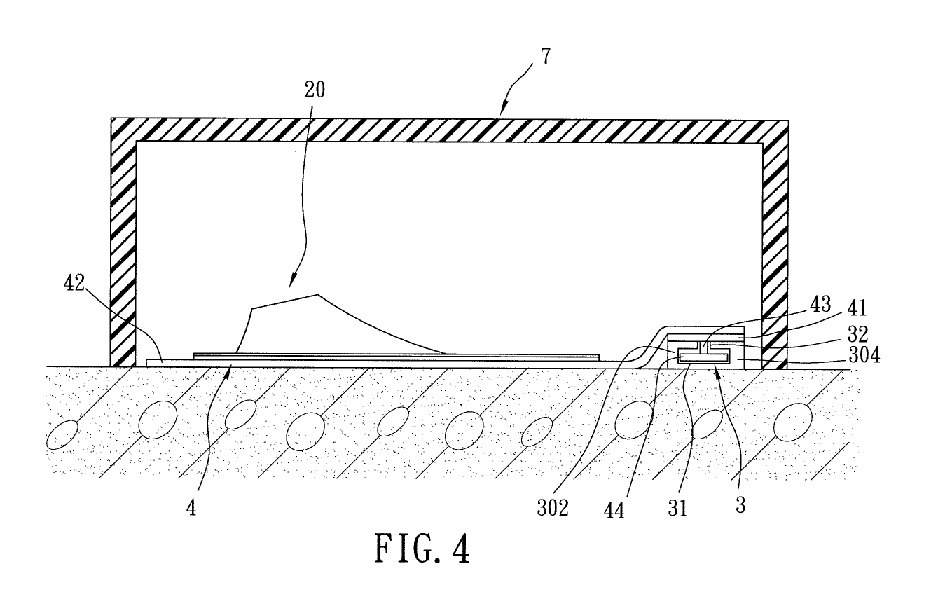

To enhance the appearance and tidiness of the device of the present invention, a storage cover 7 is disposed at the store position of the carrier 4. The storage cover 7 has an inverted-U shaped cross section, as shown in FIG. 4, and is disposed over and across a portion of the guide rail 3. The storage cover 7 covers the carrier 4 and the footwear article 20 when the carrier 4 is moved to the store position as a result of when the door panel 21 being moved to the close position.

The returning unit 8 is provided in the device of the present invention so as to further facilitate movement of the carrier 4 from the use position to the store position. With reference to FIGS. 2, 5, and 8, the returning unit 8 is disposed at the left side of the storage cover 7, and includes a coiled spring 81, a reel member 82 loaded with the coiled spring 81, and a cord 83 wound around the reel member 82. The cord 83 has an inner end portion connected to the reel member 82, and an outer end portion connected to the footwear support 42. The coiled spring 81 activates the reel member 82 to wind the cord 83 so as to pull the carrier 4 from the use position to the store position. Alternatively, a tension spring may be used to pull the carrier 4 to the store position. Hence, the construction of the returning unit 8 is not limited to the disclosed embodiment.

In this embodiment, the link member 6 is configured as an elongated bar. Alternatively, since the returning unit 8 may be used to move the carrier 4 to the store position, the link member 6 may be a string, in which case the door panel 21 is used to move the carrier 4 to the use position and not to both of the use and store positions. Hence, the construction and material of the link member 6 are not limited to the disclosed embodiment.

In use, when the door panel 21 is pushed from the close position shown in FIG. 1 to the open position shown in FIG. 2, the link member 6 pulls simultaneously the carrier 4 to move from the store position to the use position. At this time, the carrier 4 and the slippers 20 are moved out of the storage cover 7, the cord 83 is pulled out of the reel member 82, and the coiled spring 81 stores a returning force. In the use position, the slippers 20 are located near the door opening and in front of the user who desires to enter the house or the bathroom, so that the user can easily wear the slippers 20 to enter the house or bathroom.

In contrast, when the door panel 21 is pivoted to the close position, the link member 6 pushes the carrier 4 to slide along the guide rail 3 from the use position to the store position. Simultaneously, the coiled spring 81 releases the returning force at this time, and the reel member 82 is activated to wind the cord 83 back therein to thereby pull the carrier 4 back to the store position and inside the storage cover 7.

Applying the same principle, when the user leaves the house or the bathroom, the door panel 21 is pivoted to the open position, the carrier 4 is moved in front of the user, the user places the slippers 20 back on the footwear support 42, and closes the door panel 21, so that the slippers 20 and the carrier 4 are moved back inside the storage cover 7.

A method for moving the footwear article 20 between the use position that is near a door opening which is provided with the door panel 21, as shown in FIG. 2, and a store position that is away from the door opening, as shown in FIG. 1, includes the steps of: placing the footwear article 20 on the carrier 4; moving the door panel 21 to a close or open position; and transferring the movement of the door panel 21 to the carrier 4 so that the carrier 4 is moved away from or toward the door opening. The carrier 4 is moved away from the door opening when the door panel 21 is moved to the close position. The carrier 4 is moved towards the door opening when the door panel 21 is moved to the open position.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A device operable by a door panel for moving a footwear article between a use position that is near a door opening and a store position that is away from the door opening, said device comprising:
a carrier having a footwear support; and
a link member connecting said carrier to the door panel so that said carrier moves along with closing and opening movements of the door panel.

2. The device of claim 1, further comprising a guide rail adapted to be fixed on a floor, said carrier being slidable on said guide rail.

3. The device of claim 2, wherein said guide rail defines a slide channel having intercommunicating lower and upper slide sections, said upper slide section being narrower than said lower slide section, said carrier further having a slide roller sliding within said lower slide section, and a roller shaft connected to said slide roller and sliding within said upper slide section.

4. The device of claim 3, wherein said guide rail has a longitudinal bottom wall, a longitudinal top wall, and two opposite longitudinal sidewalls interconnecting said top and bottom walls, said lower slide section being defined between said top and bottom walls and between said side walls, said top wall being split to form said upper slide section.

5. The device of claim 2, wherein said link member is an elongated bar having one end connected pivotally to said carrier and another end adapted to be connected pivotally to the door panel.

6. The device of claim 2, wherein said link member is a string.

7. The device of claim 6, further comprising a returning unit to return said carrier from said use position to said store position after said carrier is pulled by said string.

8. The device of claim 7, wherein said returning unit includes a coiled spring, a reel member loaded with said coiled spring, and a cord wound around said reel member and connected to said carrier.

9. The device of claim 3, wherein said carrier further has a slide plate connected to said slide roller, said footwear support being a flexible sheet attached to said slide plate.

10. The device of claim 9, wherein said footwear support extends transversely away from said slide plate.

11. The device of claim 2, further comprising a storage cover adapted to be disposed at the store position, said storage cover being disposed over and across a portion of said guide rail and covering said footwear support when said carrier is at the store position.

12. A method for moving a footwear article between a use position that is near a door opening and a store position that is away from the door opening, the method comprising:
placing a footwear article on a carrier;
moving a door panel to a close or open position; and
transferring the movement of the door panel to the carrier so that the carrier is moved away from or toward the door opening.

13. The method of claim 12, wherein the carrier is moved away from the door opening when the door panel is moved to the close position.

14. The method of claim 12, wherein the carrier is moved towards the door opening when the door panel is moved to the open position.
